(19) United States
(12) Patent Application Publication
(10) Pub. No.: US 2013/0306486 A1
(43) Pub. Date: Nov. 21, 2013

(54) METHOD FOR MANUFACTURING COPPER FOIL FOR NEGATIVE ELECTRODE CURRENT COLLECTOR

(71) Applicants: Tomoyuki Maeda, Saitama (JP); Satoshi Torikai, Taizhong (TW); Tetsuya Kaneko, Saitama (JP); Yusuke Ozaki, Kuala Lumpur (MY); Sakiko Tomonaga, Tokyo (JP)

(72) Inventors: Tomoyuki Maeda, Saitama (JP); Satoshi Torikai, Taizhong (TW); Tetsuya Kaneko, Saitama (JP); Yusuke Ozaki, Kuala Lumpur (MY); Sakiko Tomonaga, Tokyo (JP)

(73) Assignee: MITSUI MINING & SMELTING CO., LTD., Tokyo (JP)

(21) Appl. No.: 13/807,091

(22) PCT Filed: Jun. 29, 2011
(86) PCT No.: PCT/JP2011/064888

§ 371 Date: Mar. 7, 2013

(30) Foreign Application Priority Data
Jun. 30, 2010 (JP) 2010-150115

(51) Int. Cl. H01M 4/04

(52) U.S. Cl. CPC H01M 4/0452
USPC 205/319

(57) ABSTRACT

An object of the present invention is to provide a method for manufacturing a copper foil for a negative electrode current collector (specifically, copper foil for a negative electrode current collector of a lithium ion secondary battery) more excellent in discoloration resistance to improve charge/discharge cycle life of a secondary battery. To achieve the object, a method for manufacturing a copper foil for a negative electrode current collector of a secondary battery subjecting the copper foil to rust-proofing treatment, the method characterized in that the copper foil is rust-proofing treated with a chromate-treatment solution having pH in the range from 3.5 to 7.0 to form a chromate film on the surface of the copper foil is employed.

### TECHNICAL FIELD

The present invention relates to a method for manufacturing a copper foil for a negative electrode current collector. Specifically, the present invention relates to a surface treatment method of a copper foil suitable for a negative electrode current collector of a lithium ion secondary battery.

### BACKGROUND ART

In recent years, many of portable electronic devices including cellular phones, mobile computers, portable music players and digital cameras are equipped with a built-in lithium ion secondary battery as a power source. These portable electronic devices are required to equip a secondary battery having a large discharge capacity for free use of each device in a widespread behavior area. However, when the size of a secondary battery increases to enlarge the discharge capacity, a portable electronic device equipped with the secondary battery may increase not only size but also mass. That is, discharge capacity and reduction in both size and mass are in trade-off relationship. Thus, objects in secondary battery manufacturers are increasing of the discharge capacity per unit mass and unit volume and improving of the charge/discharge cycle life of a secondary battery.

Here, in the structure of a lithium ion secondary battery, rolled copper foil or electro-deposited copper foil are used for a negative electrode current collector. Furthermore, BTA treatment or chromate-treatment inexpensive in the manufacturing cost have been employed as a rust-proofing treatment on these copper foils with great importance not to cause a cell reaction on the surface of the copper foil.

As one of the rust-proofing treatment method, Patent Document 1 discloses a method for manufacturing a copper foil used for an electrode of a secondary battery in which a copper foil surface is subjected to chromate-treatment using an alkaline chromate-treatment bath to achieve an object to provide a negative electrode current collector of the secondary battery which is improved in rust-proofing property, maintains required adhesion even in the presence of a battery electrolytic solution and achieves a long-term charge/discharge cycle.

According to Example disclosed in Patent Document 1, electro-deposited copper foil (thickness: 10 μm; manufactured by Furukawa Circuit Foil Co., Ltd.) is immersed in an alkaline solution of chromic anhydride (chromic anhydride: 6 g/L; sodium hydroxide: 15 g/L; pH: 12.5; bath temperature: 25° C.) for 5 seconds to form a chromate film of 0.024 mg-Cr/dm² on the shiny side (cathode drum side) and a chromate film of 0.018 mg-Cr/dm² on the matte side (electrolytic bath side). The copper foil provided with the chromate film does not generate discoloration after keeping for 72 hours in an atmosphere of 40° C./90% RH and after oven heating for 10 minutes at 160° C., and it has good wettability with 1-methyl-2-pyrrolidone and adhesion with carbon paste. Further, discoloration resistance is improved in the copper foil which is subjected to electrolytic chromate-treatment using the same chromate treatment bath.

Furthermore, Patent Document 2 discloses an object to provide a copper foil for a negative electrode current collector of a Li-ion secondary battery and a method for manufacturing the same. In particular, disclosed are a copper foil in which the reciprocal of the electrical double layer capacitance (1/C) is 0.1 to 0.3 cm²/μF at least on one side; and a method for manufacturing the copper foil immersing either a rolled copper foil after degreasing or an electro-deposited copper foil rinsed with water followed by drying after electro-deposition in a solution prepared by dissolving at least triazoles in a solvent or in an aqueous solution prepared by dissolving at least one selected from the group consisting of chromium trioxide, chromate salts, and dichromate salts in water.

According to Example disclosed in Patent Document 2, the non-aqueous solvent secondary battery having a jelly-roll type structure which has a large charge capacity at the first charge time and is excellent in charge/discharge cycle life is obtained by using a copper foil provided with a chromate film or a benzotriazole film as a negative electrode current collector in which the reciprocal number of the electrical double layer capacitance (1/C) on one side satisfies the range of 0.1 to 0.3 cm²/μF.

### DOCUMENTS CITED

### Patent Documents

[Patent Document 1] Japanese Patent Laid-Open No. 11-158652
[Patent Document 2] Japanese Patent Laid-Open No. 11-273683

### SUMMARY OF THE INVENTION

### Problems to be Solved by the Invention

However, although Patent Document 1 discloses the matter that the copper foil subjected to alkaline chromate-treatment does not generate discoloration after keeping for 72 hours in atmosphere of 40° C./90% RH, the copper foil generates significant discoloration with just 10° C. elevation of a temperature. That is, discoloration may generate on a copper foil surface by a seasonal factor unless the copper foil is stored in a sufficiently controlled storage environment also. Next, when the discolored copper foil is used as a negative electrode current collector, sufficient adhesion between an active material and the negative electrode current collector cannot be obtained after coating the active material because an oxide exists in the discolored portion. As a result, in the long term usage of the secondary battery, the negative electrode current collector may release the active material and an intended battery performance will be lost.

Next, Patent Document 2 discloses a method for forming an inorganic dielectric film mainly comprising a chromium hydrous oxide. However, Patent Document 2 discloses the matter that pH of a chromate-treatment solution is not limited to any particular region from an acidic region to an alkaline region when the inorganic dielectric film is formed, and discloses generally set pH in the range from 1 to 12, i.e. the importance of pH in the chromate-treatment solution is not particularly pointed out. However, the pH value of the chromate-treatment solution is an important factor for manufacturing a chromate-treated copper foil having good discoloration resistance. So, when a secondary battery manufactured by using the method disclosed in Patent Document 2 is used for long time, intended battery performance will not be achieved according to the reason described above.

When an acidic chromate-treatment method is employed as a rust-proofing treatment method for copper foil, pH of the chromate-treatment solution tends to increase in continuous treatment of a copper foil strip because hexavalent chromium may be reduced to trivalent chromium. In such a case, the adjustment to maintain pH in an acidic region using chromic anhydride, sulfuric acid, or the like may be required. However, when pH is adjusted by using sulfuric acid or the like, a chromate film may be hardly formed due to the influence of the increase in the concentration of an anion such as a sulfate group included in the chromate-treatment solution and it results a rust-proofing film poor in discoloration resistance. That is, as the improvement of the charge/discharge cycle life and the like of a secondary battery will be strongly required in the future, a method for manufacturing a copper foil for a negative electrode current collector with better discoloration resistance is required.

### Means to Solve the Problem

Thus, as a result of intensive and extensive researches, the present inventors thought out a treatment method for forming a chromate film more excellent in discoloration resistance on the surface of copper foil, and the present invention has finished.

A method for manufacturing a copper foil according to the present invention: The method for manufacturing the copper foil according to the present invention is the method for manufacturing the copper foil for a negative electrode current collector of a secondary battery wherein the copper foil is subjected to a rust-proofing treatment; characterized in that the copper foil is rust-proofing treated with a chromate-treatment solution having pH in the range from 3.5 to 7.0 to form a chromate film on the surface of the copper foil.

In the method for manufacturing the copper foil according to the present invention, it is preferable that the chromate-treatment solution having a chromium concentration of 0.3 g/L to 7.2 g/L is used.

In the method for manufacturing the copper foil according to the present invention, it is preferable that the chromate-treatment solution having a solution temperature of 15° C. to 60° C. is used; the copper foil is subjected to immersing treatment or electrolytic treatment using the solution followed by squeezing the solution from the copper foil; and the copper foil is dried by hot air at 30° C. to 150° C.

In the method for manufacturing the copper foil according to the present invention, it is preferable that the copper foil is immersed in the chromate-treatment solution for 0.5 seconds to 10 seconds in the immersing treatment.

In the method for manufacturing the copper foil according to the present invention, it is preferable that the copper foil dipped in the chromate-treatment solution is set as a cathode and electrolyzed at a cathode current density of 0.1 A/dm² to 25 A/dm² for 0.5 seconds to 10 seconds in the electrolytic treatment.

### Advantage of the Invention

When the rust-proofing treatment method according to the present invention characterized in that the copper foil is treated with a chromate-treatment solution having pH in the range from 3.5 to 7.0 to form a chromate film on the surface of the copper foil is employed, discoloration resistance of the copper foil for a negative electrode current collector which duration has been limited to 72-hour keeping in a 40° C./90% RH atmosphere can be improved to a level 48-hour keeping in a 50° C./95% RH atmosphere.

### EMBODIMENTS OF THE INVENTION

Method for manufacturing a copper foil according to the present invention: In the method for manufacturing the copper foil according to the present invention, the copper foil is rust-proofing treated with a chromate-treatment solution having pH in the range from 3.5 to 7.0 to form a chromate film on the surface of the copper foil. When the copper foil is rust-proofing treated with a chromate-treatment solution controlled in such pH range, a chromate film having good performance such as discoloration resistance with small deviation can be formed on a copper foil surface. However, when pH of the chromate-treatment solution is less than 3.5, the concentration of the anion such as a sulfate ion used for pH adjustment may increase and it affects on the reactivity of other anions such as dichromate ion. As a result, the formed chromate film tends to be poor in discoloration resistance. So, it is not preferable. In contrast, when pH exceeds 7.0, hexavalent chromium cannot exist in the form of dichromate ion but takes a form such as a chromate ion hardly form a chromate film. So, it is not preferable. Further, when pH of the chromate-treatment solution exceeds 6.2, copper ions included in a very small amount may precipitate copper hydroxide. Then, the chromate film tends not to be formed on the copper foil surface where the precipitate puts. So, more preferable pH of the chromate-treatment solution is 3.5 to 6.2. Furthermore, from the point of view further improving discoloration resistance, pH of the chromate-treatment solution is more preferably adjusted in the range from 3.5 to 5.9.

In the method for manufacturing the copper foil according to the present invention, the chromate-treatment solution having a chromium concentration of 0.3 g/L to 7.2 g/L is used. When copper foil is treated for a specific time with the chromate-treatment solution adjusted to such a concentration, a chromate film having good performance such as discoloration resistance with small deviation can be formed on the copper foil surface. However, when the chromium concentration in the chromate-treatment solution is less than 0.3 g/L, formation of good chromate film tends to be hard even with the longer chromate-treatment time. So, it is not preferable. In contrast, the upper limit of the chromium concentration is open from the point of view in discoloration resistance, but when the chromium concentration in the chromate-treatment solution exceeds 7.2 g/L, unevenness may be observed in a copper foil surface. Next, when the deposit of hexavalent chromium which is a toxic substance increases, use of the copper foil may be not allowed in applications which regulates severe environmental load. So, it is not preferable. Furthermore, in consideration of the waste treatment including disposed rinsed water after the chromate-treatment and disposed chromate-treatment solution, the chromium concentration in the chromate-treatment solution is preferable to be controlled in a low level. From such a point of view, the chromium concentration in the chromate-treatment solution is more preferable to be in the range from 0.3 g/L to 1.0 g/L.

In the method for manufacturing the copper foil according to the present invention, the chromate-treatment solution having the solution temperature of 15° C. to 60° C. is used; the copper foil is subjected to immersing treatment or electrolytic treatment using the chromate-treatment solution followed by squeezing the solution from the copper foil; and the copper foil is dried by hot air at 30° C. to 150° C.

Here, reaction systems in formation of the chromate film in the immersing chromate-treatment method and the electrolytic chromate-treatment method will be investigated. In the immersing chromate-treatment method, substitution reaction is considered to be the main reaction, and in the electrolytic chromate-treatment method, electro-deposition is considered to be the main reaction. However, when attention is paid to the in-plane deviation among surface properties, it is considered that the chromate film formed by a substitution reaction using the immersing chromate-treatment method has a smaller in-plane deviation than the in-plane deviation of chromate film obtained by using the electrolytic chromate-treatment method. The reason is that in the electrolytic chromate-treatment method, the in-plane deviation of the chromate film obtained by the electrolytic chromate-treatment method is a little larger because it is affected by the current density distribution inevitably generate in the surface of copper foil. However, when the formed chromate film uniformly deposits on copper foil at a specific level, the deviation may hardly affect on the performance of a secondary battery when the copper foil is used as a negative electrode current collector.

Next, the solution temperature of the chromate-treatment solution will be described. It is supposed that higher the solution temperature is the better in the immersing chromate-treatment method because substitution reaction is the main reaction. However, the chromate film formed by the substitution reaction is substantially a monomolecular film, and sufficient discoloration resistance cannot be achieved by the monomolecular film. So, a chromate film further adsorbed on the monomolecular chromate film is necessary to perform the intended discoloration resistance. Because such an adsorbed state can be obtained more stable at a lower temperature, it is preferable to employ a solution temperature of rather lower.

However, when the solution temperature of the chromate-treatment solution is less than 15° C., slower substitution reaction which uniformly forms a monomolecular chromate film necessary to the copper foil surface may make the productivity poor. So, it is not preferable. In contrast, when the solution temperature of the chromate-treatment solution exceeds 60° C., the thickness of the adsorbed chromate film may have a large deviation and stable discoloration resistance may hardly be achieved. So, it is not preferable.

Next, as for the solution temperature of the chromate-treatment solution in the case subjecting the copper foil to electrolytic treatment, when the temperature is set at 15° C. to 60° C. as in the immersing treatment, temperature control can be made common to the immersing chromate-treatment solution. Note that in the electrolytic chromate-treatment method, even when the solution temperature is out of the temperature range, similar troubles as in the immersing chromate-treatment method will never occur.

When the copper foil is subjected to immersing treatment, the process immersing the copper foil in the chromate-treatment solution for 0.5 seconds to 10 seconds is adopted. When the copper foil is subjected to immersing chromate-treatment for 0.5 seconds to 10 seconds followed by squeezing the solution, a chromate film having a thickness by weight of 1.0 mg/m² to 3.9 mg/m² in terms of chromium metal is formed on the surface of the copper foil, and good discoloration resistance will be performed. However, when the time to immerse the copper foil in the chromate-treatment solution is less than 0.5 seconds, a portion where a substitution reaction is insufficient may be generated on the copper foil surface, and discoloration resistance may be insufficient locally. So, it is not preferable. In contrast, even when the time to immerse the copper foil in the chromate-treatment solution exceeds 10 seconds, discoloration resistance may not be improved any more. So, the productivity of copper foil is reduced to increase the manufacturing cost. So, it is not preferable.

Here, a method for squeezing the chromate-treatment solution from the copper foil after immersing in the solution will be described. As described above, the chromate film formed by the immersing chromate-treatment method is in the state in which a chromate layer further adsorbs on a thin chromate film of a monomolecular film level. So, the chromate film may release when mechanical rubbing occurs. Thus, squeezing methods employed include a method for uniformly squeezing the copper foil without mechanical contact such as an air blow method using an air knife and a method for not generating rubbing even when the copper foil is in contact. Note that the thickness by weight in terms of chromium metal as described above is a value in the case using such a squeezing method, but it should be clearly demonstrated that the value does not significantly vary even when a water rinsing step is provided after the chromate-treatment step.

When copper foil is subjected to electrolytic treatment, the copper foil dipped in the chromate-treatment solution is set as a cathode and electrolyzed at a cathode current density of 0.1 A/dm² to 25 A/dm² for an electrolysis time of 0.5 seconds to 10 seconds. When copper foil is subjected to electrolytic chromate-treatment under such conditions, a chromate film having a thickness by weight of 1.0 mg/m² to 3.9 mg/m² in terms of chromium metal is formed on the surface of the copper foil, and good discoloration resistance will be performed, as in the case where the copper foil is subjected to immersing chromate-treatment. However, when the time to subject the copper foil to electrolytic chromate-treatment is less than 0.5 seconds, a uniform electrolytic chromate film may not be formed on the copper foil surface, and intended discoloration resistance may hardly be performed at some portion. So, it is not preferable. In contrast, even when the time to subject the copper foil to electrolytic chromate-treatment exceeds 10 seconds, the effect for forming a uniform chromate film may have already saturated, and discoloration resistance may not be improved any more. So, just the productivity of copper foil is reduced and increases the manufacturing cost. So, it is not preferable.

Next, when the cathode current density is less than 0.1 A/dm², it may be difficult to obtain a uniform chromate film because the surface potential distribution greatly deviates in the copper foil. So, it is not preferable. In contrast, when cathode current density exceeds 25 A/dm², hydrogen tends to generate from the copper foil surface. In such a case, the hydrogen gas put on the copper foil surface may obstruct the formation of a uniform chromate film on the copper foil surface. So, it is not preferable. So, a cathode current density of 0.5 A/dm² to 5.0 A/dm² is more preferable to maintain stable manufacturing.

The copper foils subjected to the chromate-treatment using the above-described methods are dried by using hot air at a temperature 30° C. to 150° C. Note that any chromate film formed on the copper foil surface by the immersing chromate-treatment method or the electrolytic chromate-treatment method includes hydroxy groups. So, the film is difficult to perform discoloration resistance as it is. However, when the hydroxy groups included in the chromate film are decomposed by drying and evaporate water to form a chromate film containing an appropriate amount of hydroxy groups, properties including discoloration resistance may be improved. Incidentally, a method irradiating far-infrared rays or the like to activate the motion of water molecules for evaporation is popularly employed in the drying step because it is excellent in energy efficiency. However, when such a drying method is employed, it may be difficult to control the temperature of the copper foil surface, i.e. the chromate film, because copper foil reflects far-infrared rays very well. Then, the drying is performed by blowing hot air on the copper foil in the present invention. When hot air is used, the chromate film is surely heated by the thermal conduction between the heated copper foil and the chromate film. At the same time, the temperature of the copper foil does not elevate to a temperature higher than the temperature of the hot air, and a change in the physical properties of the copper foil by heating hardly occurs. So, the drying using hot air is preferable.

However, when the temperature of the hot air is less than 30° C., the decomposition of the hydroxy groups may be insufficient with decreasing of the drying time, and it may be difficult to finish a chromate film excellent in discoloration resistance. In contrast, when the temperature of the hot air exceeds 150° C., the decomposition of the hydroxy groups included in the chromate film may be excessive even in the short-time drying and a lot of cracks may generate in the chromate film. As a result, the covering of the copper foil by the chromate film is made insufficient, and the chromate film cannot perform the function as a rust-proofing film. So, it is not preferable. Further, when the copper foil provided with a chromate film is kept at a temperature about 100° C. for a long time, a crack may generate in the chromate film also. From such a point of view, it is more preferable to dry the copper foil using hot air at 30° C. to 70° C. Optionally, the chromate-treatment solution put on the copper foil can be rinsed with water before drying. When the copper foil is rinsed with water, the anions or cations included in the chromate-treatment solution may not remain on the copper foil surface, and it greatly contributes to improvement of discoloration resistance.

The discoloration resistance of the chromate-treated copper foil manufactured by using the method for manufacturing the copper foil according to the present invention is evaluated on the drum-side surface of the electro-deposited copper foil. Because the drum-side surface has a stable microscopic surface shape, the comparative evaluation of the chromate films formed on the surface is made easy. Particularly, as described later in Examples, the gloss (Gs)(60°) before and after treatment in the constant temperature and humidity atmosphere (keeping for 48 hours in a 50° C./95% RH atmosphere) is measured in the transverse direction of the drum-side surface, and when the value of ΔGs (difference in gloss) which shows the difference between the gloss before treatment in the constant temperature and humidity atmosphere (Gs-A) and the gloss after treatment in the constant temperature and humidity atmosphere (Gs-EH) shown in the following Expression 1 is 20 or less, the discoloration resistance can be quantitatively judged to be good. According to the evaluation method, the value of ΔGs (difference in gloss) of the chromate-treated copper foil in Comparative Example 4 described later as a chromate-treated copper foil manufactured tracing the invention disclosed in Patent Document 1 is 63.7, and the values of ΔGs (difference in gloss) in the present Examples are 20 or less. So, when the values of ΔGs are in the range, the copper foil is judged excellent in discoloration resistance.

ΔGs=(Gs−A)−(Gs−EH) [Expression 1]

Gs−A: Gloss Gs (60°) as received
Gs−EH: Gloss Gs (60°) after keeping for 48 hours in a 50° C./95% RH atmosphere

Furthermore, the discoloration resistance of the chromate-treated copper foil manufactured by using the method for manufacturing a copper foil for a negative electrode current collector according to the present invention can be quantitatively judged to be good, when the color indexes (L*/a*/b*) of the drum-side surface before and after treatment in the constant temperature and humidity atmosphere is measured, and the value of the color difference which is the square root of the sum of squares of the difference between each color index shown in the following Expression 2 is 2.0 or less. According to the evaluation method, the value of the color difference of the chromate-treated copper foil in Comparative Example 4 is 18.0, and the values of the color difference in the present Examples are 2.0 or less. So, when the values of the color difference are in the range, the copper foil is judged excellent in discoloration resistance.

Color Difference=\sqrt{ΔL*²+Δa*²+Δb*²} [Expression 2]

ΔL*=[L value as received]−[L* value after keeping in a 50° C./95% RH atmosphere for 48 hours]
Δa*=[a* value as received]−[a* value after keeping in a 50° C./95% RH environment for 48 hours]
Δb*=[b* value as received]−[b* value after keeping in a 50° C./95% RH environment for 48 hours]

### Example 1

### Preparation of a Chromate-Treated Copper Foil

In Example 1, a chromate-treatment solution was prepared by dissolving chromic anhydride in deionized water to prepare a chromic acid solution having a chromium concentration of 0.6 g/L followed by adjusting pH of the chromic acid solution to 5.7 with caustic soda. The 8 μm thick untreated electro-deposited copper foil (DFF: manufactured by Mitsui Mining and Smelting Co., Ltd.) was used for the copper foil to be subjected to chromate-treatment. Pickling of the copper foil was carried out by immersing in an aqueous 100 g/L sulfuric acid solution for 30 seconds and then rinsed with water by immersing in deionized water for 30 seconds. In the chromate-treatment, the chromate-treatment solution gently stirred in a glass beaker was adjusted at a solution temperature of 40° C., the copper foil was immersed for 3 seconds followed by squeezing the solution, and was dried for 3 seconds with hot air at a temperature of 70° C. to prepare the chromate-treated copper foil. The test conditions described above are shown in the following Table 1 together with the test conditions of Examples 2 to 9, Comparative Examples 1 to 5, and Reference Example described later.

### [Evaluation of Discoloration Resistance of a Chromate-Treated Copper Foil]

The chromate-treated copper foil prepared in Example 1 was evaluated discoloration resistance by measuring the gloss Gs (60°) at the drum-side surface in the transverse direction by a gloss meter (VG-2000: manufactured by Nippon Denshoku Industries Co., Ltd.) and measuring the color indexes L*/a*/b* by a spectrophotometer (SE-2000: manufactured by Nippon Denshoku Industries Co., Ltd.) before and after treatment in the constant temperature and humidity atmosphere (keeping in the constant temperature and humidity bath set at 50° C./95% RH for 48 hours). The evaluation results are shown later in the following Table 2 together with the evaluation results of the chromate-treated copper foils prepared in Examples 2 to 9, Comparative Examples 1 to 5, and Reference Example.

### Example 2

In Example 2, chromate-treated copper foil was prepared in the same manner as in Example 1 except that pH of the chromate-treatment solution prepared in Example 1 was adjusted to 4.5; and discoloration resistance was evaluated. The evaluation results are shown later in the Table 2.

### Example 3

In Example 3, chromate-treated copper foil was prepared in the same manner as in Example 1 except that pH of the chromate-treatment solution prepared in Example 1 was adjusted to 6.2; and discoloration resistance was evaluated. The evaluation results are shown later in the Table 2.

### Example 4

In Example 4, chromate-treated copper foil was prepared in the same manner as in Example 1 except that the chromium concentration of the chromate-treatment solution prepared in Example 1 was adjusted to 0.3 g/L; and discoloration resistance was evaluated. The evaluation results are shown later in the Table 2.

### Example 5

In Example 5, chromate-treated copper foil was prepared in the same manner as in Example 1 except that the temperature of hot air was adjusted to 100° C.; and discoloration resistance was evaluated. The evaluation results are shown later in the Table 2.

### Example 6

In Example 6, chromate-treated copper foil was prepared in the same manner as in Example 1 except that pH of the chromate-treatment solution prepared in Example 3 was adjusted to 5.7 by adding sulfuric acid; and discoloration resistance was evaluated. The evaluation results are shown later in the Table 2.

### Example 7

In Example 7, chromate-treated copper foil was prepared by electrolyzing copper foil at a cathode current density of 1.0 A/dm² for 1.5 seconds using a dimensional stable anode (DSA) as the counter electrode in the chromate-treatment solution prepared in Example 1 at a solution temperature of 40° C.; followed by water rinsing and squeezing, followed by drying with hot air at a temperature of 70° C. The chromate-treated copper foil prepared in Example 7 was evaluated discoloration resistance in the same manner as in Example 1. The evaluation results are shown later in the Table 2.

### Example 8

In Example 8, chromate-treated copper foil was prepared in the same manner as in Example 7 except that the chromate-treatment solution prepared in Example 2 at a solution temperature of 40° C. was used; and discoloration resistance was evaluated in the same manner as in Example 1. The evaluation results are shown later in the Table 2.

### Example 9

In Example 9, chromate-treated copper foil was prepared in the same manner as in Example 7 except that the chromate-treatment solution prepared in Example 3 at a solution temperature of 40° C. was used; and discoloration resistance was evaluated in the same manner as in Example 1. The evaluation results are shown later in the Table 2.

### COMPARATIVE EXAMPLES

### Comparative Example 1

In Comparative Example 1, chromate-treated copper foil was prepared in the same manner as in Example 1 except that pH of the chromate-treatment solution prepared in Example 1 was re-adjusted to 7.2; and discoloration resistance was evaluated. The evaluation results are shown later in the Table 2.

### Comparative Example 2

In Comparative Example 2, chromate-treated copper foil was prepared in the same manner as in Example 1 except that the chromate-treatment solution prepared to have a chromium concentration of 3.6 g/L and pH adjusted to 6.5 of pH was re-adjusted to 3.2 by adding sulfuric acid was used; and discoloration resistance was evaluated. The evaluation results are shown later in the Table 2.

### Comparative Example 3

In Comparative Example 3, chromate-treated copper foil was prepared in the same manner as in Example 1 except that a chromate-treatment solution prepared to have a chromium concentration of 3.6 g/L and pH adjusted to 12.5 was used; and discoloration resistance was evaluated. The evaluation results are shown later in the Table 2.

### Comparative Example 4

In Comparative Example 4, chromate-treated copper foil tracing Example 1 disclosed in Patent Document 1 was prepared and evaluated discoloration resistance. The evaluation results are shown later in the Table 2.

### Comparative Example 5

In Comparative Example 5, chromate-treated copper foil was prepared in the same manner as in Example 1 except that a chromate-treatment solution after subjecting a plural pieces of copper foil to chromate-treatment one by one using the chromate-treatment solution prepared in the Reference Example described below, and when pH reached 3.0, pH of chromate-treatment solution was adjusted again to 1.3 by adding sulfuric acid was used; and discoloration resistance was evaluated. The evaluation results are shown later in the Table 2.

### Reference Example

In Reference Example, chromate-treated copper foil was prepared in the same manner as in Example 1 except that the chromate-treatment solution prepared to have a chromium concentration of 3.6 g/L and pH of 1.3 was used; and discoloration resistance was evaluated. The evaluation results are shown later in the Table 2.

TABLE 1

| | | | | | | | | Drying | |
|---|---|---|---|---|---|---|---|---|---|
| | | | Concent- | | Solution | Treatment | | Hot-air | |
| | | | ration of | | Temp. | Time | DA | Temp. | Time |
| | | Method | Cr (g/L) | pH | (deg. − C.) | (sec) | (A/dm²) | (deg. − C.) | (sec) |
| Example | 1 | Immersing | 0.6 | 5.7 | 40 | 3 | — | 70 | 3 |
| | 2 | | 0.6 | 4.5 | 40 | 3 | — | 70 | 3 |
| | 3 | | 0.6 | 6.2 | 40 | 3 | — | 70 | 3 |
| | 4 | | 0.6 | 5.7 | 40 | 3 | — | 70 | 3 |
| | 5 | | 0.6 | 5.7 | 40 | 3 | — | 100 | 3 |
| | 6 | | 0.6 | 5.7* | 40 | 3 | — | 70 | 3 |
| | 7 | Electroly- | 0.6 | 5.7 | 40 | 3 | 1.5 | 70 | 3 |
| | 8 | sis | 0.6 | 4.5 | 40 | 1.5 | 1.5 | 70 | 3 |
| | 9 | | 0.6 | 6.2 | 40 | 1.5 | 1.5 | 70 | 3 |
| Compara- | 1 | Immersing | 0.6 | 7.2 | 40 | 1.5 | — | 70 | 3 |
| tive | 2 | | 3.6 | 3.2* | 40 | 3 | — | 70 | 3 |
| Example | 3 | | 3.6 | 12.5 | 40 | 3 | — | 70 | 3 |
| | 4 | | 3.12 | 12.5 | 25 | 3 | — | 70 | 3 |
| | 5 | | 3.6 | 1.3* | 40 | 3 | — | 70 | 3 |

| | | | | | | | | |
|---|---|---|---|---|---|---|---|---|
| Reference | Immersing | 3.6 | 1.3 | 40 | 3 | — | 70 | 3 |
| Example | | | | | | | | |

Notes:
*refers to pH adjusted by adding sulfuric acid

TABLE 2

Color Index (L*/a*/b*)

| | | |
|---|---|---|
| Gloss (Gs (60-deg.)) | After | Color |

| | | Gs-A | Gs-EH | ΔGs | As Received | Treatment | Difference |
|---|---|---|---|---|---|---|---|
| Example | 1 | 82.0 | 80.0 | 2.0 | 53.0/9.6/8.6 | 52.5/9.7/9.2 | 0.84 |
| | 2 | 86.6 | 82.1 | 4.6 | 52.5/9.6/8.4 | 51.8/9.3/9.0 | 0.97 |
| | 3 | 86.1 | 81.7 | 4.4 | 52.9/9.6/8.4 | 52.0/9.6/9.1 | 1.13 |
| | 4 | 83.3 | 80.7 | 2.6 | 52.3/9.6/8.5 | 51.4/9.6/8.8 | 0.99 |
| | 5 | 83.2 | 81.0 | 2.2 | 52.5/12.2/10.3 | 52.8/12.1/10.5 | 0.45 |
| | 6 | 85.9 | 85.7 | 0.3 | 54.0/9.8/8.9 | 55.4/10.0/9.7 | 1.62 |
| | 7 | 88.7 | 89.6 | 0.0 | 54.5/10.1/9.1 | 53.9/10.0/9.5 | 0.68 |
| | 8 | 85.3 | 80.9 | 4.3 | 55.2/10.0/9.1 | 54.5/9.8/9.4 | 0.88 |
| | 9 | 79.9 | 78.0 | 1.9 | 55.6/10.0/9.1 | 55.1/10.1/9.8 | 0.86 |
| Compara- | 1 | 81.5 | 41.6 | 39.9 | 54.0/9.8/8.7 | 56.6/10.2/10.6 | 3.16 |
| tive | 2 | 82.9 | 61.2 | 21.6 | 53.9/9.8/8.7 | 51.7/9.3/9.3 | 2.30 |
| Example | 3 | 81.2 | 14.1 | 67.1 | 55.3/10.0/9.8 | 36.7/10.0/7.3 | 18.7 |
| | 4 | 80.8 | 17.1 | 63.8 | 55.1/9.9/9.7 | 38.3/4.9/5.6 | 18.0 |
| | 5 | 76.4 | 23.7 | 52.7 | 54.2/9.5/8.2 | 39.4/5.5/7.2 | 15.4 |

| | | | | | | |
|---|---|---|---|---|---|---|
| Reference | 78.7 | 78.2 | 0.6 | 54.4/9.8/8.9 | 56.0/10.1/9.6 | 1.79 |
| Example | | | | | | |

### Comparison Among Examples and Comparative Examples

ΔGs (Gloss Difference): In comparison among Examples 1 to 6 and Comparative Examples 1 to 5, the values of ΔGs (Gloss Difference) of the chromate-treated copper foil prepared in Examples are 0.3 to 4.6, and are at a level of 1/10 against to the values of ΔGs (Gloss Difference) of the chromate-treated copper foil prepared in Comparative Examples of 21.6 to 67.1. By the way, although the chromate-treated copper foils prepared in Examples 1 to 6 are subjected to immersing chromate-treatment, the values of ΔGs (Gloss Difference) show almost the same, good level as those of the chromate-treated copper foils prepared in Examples 7 to 9 subjected to electrolytic chromate-treatment.

Color Difference: In comparison among Examples 1 to 6 and Comparative Examples 1 to 5, the values of the color difference of the chromate-treated copper foil prepared in Examples are 0.45 to 1.62, and are at a level of ½ or less of the value of the color difference of the chromate-treated copper foils prepared in Comparative Examples of 2.30 to 18.7. Here, all the values of the color difference of the chromate-treated copper foils prepared in Examples 1 to 6 were 2.0 or less judged good while the value of the color difference of the chromate-treated copper foil prepared in Comparative Example 4 was 18.0. From these results, it can be understood that the chromate-treated copper foil prepared in Comparative Example 4 by tracing an Example 1 of Patent Document 1 may be a level durable for 72 hours in the constant temperature and humidity chamber at 40° C./90% RH, but it is not durable for 48 hours in the constant temperature and humidity chamber at 50° C./95% RH. Although the chromate-treated copper foils prepared in Examples 1 to 6 are subjected to immersing chromate-treatment, the values of color difference show almost the same level, good level as those of the chromate-treated copper foils prepared in Examples 7 to 9 subjected to electrolytic chromate-treatment.

### Comparison between Reference Example and Comparative Example 5

The values of ΔGs (Gloss Difference) and the color difference of the chromate-treated copper foil prepared in Reference Example were 0.6 and 1.79 respectively, and are the same level in discoloration resistance as the chromate-treated copper foils prepared in Examples. In contrast, in the chromate-treated copper foil prepared in Comparative Example 5, the values of ΔGs (Gloss Difference) and the color difference were 52.7 and 15.4 respectively, i.e. the chromate-treated copper foil prepared in Comparative Example 5 is apparently poor in discoloration resistance.

Then, the reasons why discoloration resistances are greatly differ between Reference Example and Comparative Example 5 will be investigated. PH of the chromate-treatment solution used in Comparative Example 5 was adjusted again to 1.3 with sulfuric acid after increasing pH of the chromate-treatment solution used in Reference Example through repeated chromate-treatment. That is, the chromate-treatment solution used in Comparative Example 5 is contaminated with a plenty of sulfate ions used for pH adjustment compared to the chromate-treatment solution used in Reference Example. So, it has been confirmed that sulfate ions included in a concentration at a specific level obstructs the formation of a stable chromate film.

Note that in an immersing chromate-treatment method using an acidic chromate-treatment solution, a case is assumed where copper foil is subjected to chromate-treatment while adjusting pH with sulfuric acid or the like. However, in such a case, not only the renewal of the chromate-treatment solution is required but also a stable manufacturing of the chromate-treated copper foil having intended discoloration resistance may be made difficult because the formation of a good chromate-treated film is difficult when sulfate ion concentration reached a specific level.

As described above, it has been confirmed that the level of discoloration resistance in a high temperature and high humidity environment of the chromate-treated copper foil prepared in Examples is apparently far excellent to the chromate-treated copper foil prepared in Comparative Example 4 tracing the method described in Patent Document 1. Further, in comparison between chromate-treated copper foils prepared in Example 2 and Comparative Example 2 using a chromate-treatment solution having lower pH, discoloration resistance is greatly made poor only by adjusting pH of the chromate-treatment solution from 4.5 to 3.2. In contrast, in comparison between chromate-treated copper foils prepared in Example 3 and Comparative Example 1 using a chromate-treatment solution having higher pH, discoloration resistance is greatly made poor only by adjusting pH of the chromate-treatment solution from 6.2 to 7.2. So, it has been confirmed that just pH adjusting of the chromate-treatment solution in the range from 1 to 12 disclosed in Patent Document 2 is not sufficient, and pH adjusted from 3.5 to 7.0 is an important factor in manufacturing of a chromate-treated copper foil having good discoloration resistance. Further, at pH range of less than 3.5, it has been confirmed that sulfate ions included in a specific concentration hinders the formation of a good chromate film.

### INDUSTRIAL APPLICABILITY

When the method for manufacturing a copper foil according to the present invention is employed, the chromate-treated copper foil excellent in discoloration resistance is manufactured even when the chromium concentration in a chromate-treatment solution is low. So, the amount of hexavalent chromium required for manufacturing of the chromate-treated copper foil is reduced, and it makes management of hazardous materials which will be under severer regulation in the future easy. So, the method is applicable to not only the manufacturing of copper foil for negative electrode current collectors but also the surface treatment of copper foil in a wide range of applications.

1. A method for manufacturing a copper foil for a negative electrode current collector of a secondary battery wherein the copper foil is subjected to a rust-proofing treatment, characterized in that
the copper foil is rust-proofing treated with a chromate-treatment solution having pH in the range from 3.5 to 7.0 to form a chromate film on the surface of the copper foil.

2. The method for manufacturing the copper foil according to claim 1, wherein
the chromate-treatment solution having a chromium concentration of 0.3 g/L to 7.2 g/L is used.

3. The method for manufacturing the copper foil according to claim 1, wherein
the chromate-treatment solution having a solution temperature of 15° C. to 60° C. is used; the copper foil is subjected to immersing treatment or electrolytic treatment using the solution followed by squeezing the solution from the copper foil; and the copper foil is dried by hot air at 30° C. to 150° C.

4. The method for manufacturing the copper foil according to claim 3, wherein
the copper foil is immersed in the chromate-treatment solution for 0.5 seconds to 10 seconds in the immersing treatment.

5. The method for manufacturing the copper foil according to claim 3, wherein
the copper foil dipped in the chromate-treatment solution is set as a cathode and electrolyzed at a cathode current density of 0.1 A/dm² to 25 A/dm² for 0.5 seconds to 10 seconds in the electrolytic treatment.

6. The method for manufacturing the copper foil according to claim 2, wherein
the chromate-treatment solution having a solution temperature of 15° C. to 60° C. is used; the copper foil is subjected to immersing treatment or electrolytic treatment using the solution followed by squeezing the solution from the copper foil; and the copper foil is dried by hot air at 30° C. to 150° C.

7. The method for manufacturing the copper foil according to claim 6, wherein
the copper foil is immersed in the chromate-treatment solution for 0.5 seconds to 10 seconds in the immersing treatment.

8. The method for manufacturing the copper foil according to claim 6, wherein
the copper foil dipped in the chromate-treatment solution is set as a cathode and electrolyzed at a cathode current density of 0.1 A/dm² to 25 A/dm² for 0.5 seconds to 10 seconds in the electrolytic treatment.
